(19) United States
(12) Patent Application Publication
(10) Pub. No.: US 2008/0262731 A1
(43) Pub. Date: Oct. 23, 2008

(54) Electronic device for FM transmission of location-based information

(76) Inventor: Prasan Kumar Pai, Mission Viejo, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/788,338

(22) Filed: Apr. 18, 2007

(51) Int. Cl. G06G 7/78

(52) U.S. Cl. 701/300

(57) ABSTRACT

According to one embodiment, an electronic device, for example, a portable electronic device such as a cellular telephone, a portable navigation device, a personal digital assistant (“PDA”), or an MP3 player, includes a GPS receiver configured to receive GPS coordinates. The GPS coordinates are sent to a CPU that is configured to retrieve location-based information from, for example, a memory device or a cellular module in the electronic device. An FM transmitter module is configured to encode and transmit the location-based information as encoded text, for example encoded RDS text, to an FM receiver in a vehicle. The RDS text can then be displayed on a display panel of the FM receiver. In addition to the encoded RDS text, audio signals from the FM transmitter module can be transmitted to the FM receiver for broadcast by a speaker of the FM receiver contemporaneously with the display of the RDS text.

### BACKGROUND OF THE INVENTION

1. Field of the Invention

The present invention is generally in the field of electronics. More particularly, the present invention is in the field of techniques for transmitting and using Global Positioning System (“GPS”) data.

2. Background

Portable electronic devices that are equipped with Global Positioning System (“GPS”) receivers, such as portable navigation devices, can provide many significant advantages. For example, such portable electronic devices can navigate a user to desired destinations with great convenience and ease. Moreover, such portable electronic devices can guide a lost traveler back onto her intended course, can determine alternative routes to a destination to reduce travel time, and can guide a traveler to various locations of interest, such as gas stations and restaurants. As such, users typically use these portable GPS-equipped electronic devices while operating vehicles, such as automobiles and boats.

However, effective use of these GPS-equipped portable electronic devices during the operation of a moving vehicle is cumbersome, inconvenient, and can also pose a safety risk to the user as well as to other passengers that might be present in the moving vehicle. For example, a user operating a moving vehicle may be frequently required to remove her eyes from the path of travel for significant periods of time to read the information displayed on the portable electronic device, thus distracting the user and increasing the likelihood of an accident. Moreover, even if the portable electronic devices are equipped with integrated speakers which allow the output of audible instructions, such integrated speakers tend to be very weak and cannot be heard in noisy environments, especially while the vehicle is moving.

### SUMMARY OF THE INVENTION

An electronic device for FM transmission of location-based information, substantially as shown in and/or described in connection with at least one of the figures, as set forth more completely in the claims.

### BRIEF DESCRIPTION OF THE DRAWINGS

FIG. 1 is a block diagram of a portable electronic device capable of transmitting Global Positioning System (“GPS”) data and an FM receiver for receiving such data, in accordance with an embodiment of the present invention.

FIG. 2 shows a block diagram of an FM transmitter module coupled to a central processing unit (“CPU”) in accordance with one embodiment of the invention.

FIG. 3 shows a front view of an example FM receiver capable of implementing an embodiment of the present invention.

### DETAILED DESCRIPTION OF THE INVENTION

The present invention is directed to an electronic device for FM transmission of location-based information. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings.

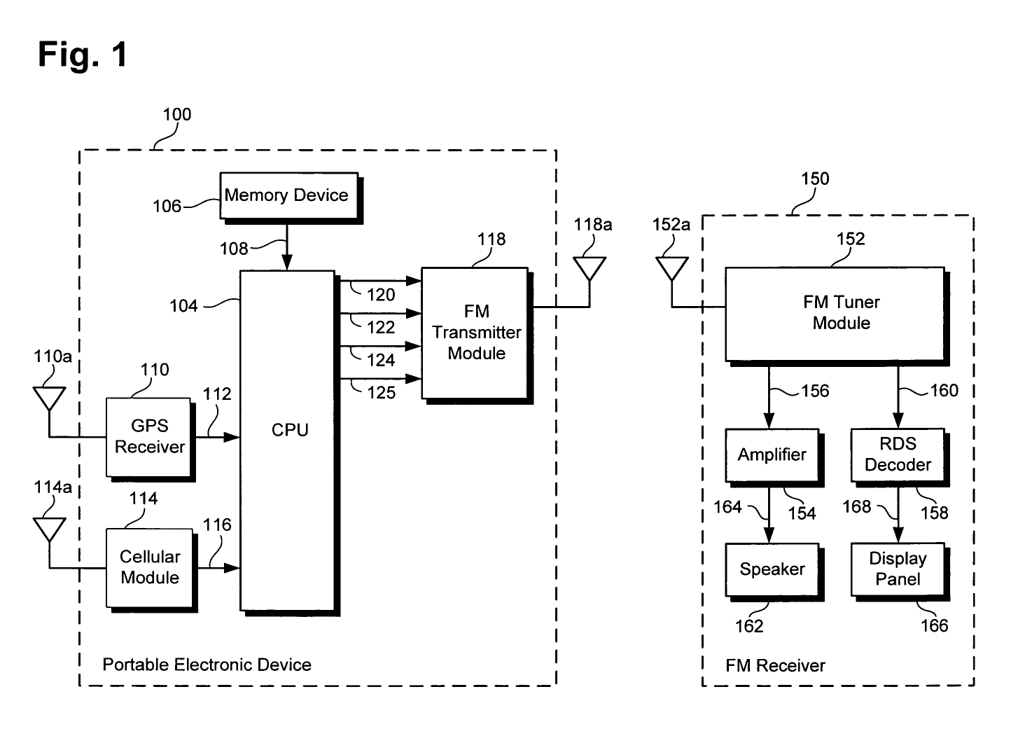

FIG. 1 is a block diagram of a portable electronic device capable of transmitting Global Positioning System (“GPS”) data and a frequency modulation (“FM”) receiver for receiving such data, in accordance with an embodiment of the present invention. In one embodiment, portable electronic device 100 (also referred to generally as an “electronic device”) includes central processing unit (“CPU”) 104, memory device 106, GPS receiver 110, cellular module 114, and FM transmitter module 118. As also shown in FIG. 1, memory device 106, GPS receiver 110, and cellular module 114 are coupled to CPU 104 via buses 108, 112, and 116, respectively, and FM transmitter module 118 is coupled to CPU 104 via text data bus 120, analog audio bus 122, digital audio bus 124, and control bus 125. As further shown in FIG. 1, GPS receiver 110 is coupled to antenna 110a, cellular module 114 is coupled to antenna 114a, and FM transmitter module is coupled to antenna 118a. In one embodiment, portable electronic device 100 can be, by way of specific examples and without limitation, a cellular telephone, a portable navigation device, a personal digital assistant (“PDA”), or an MP3 player, or the like.

FM receiver 150 shown in FIG. 1 includes FM tuner module 152, amplifier 154, Radio Data System (“RDS”) decoder 158, speaker 162, and display panel 166. FM receiver 150 can be, for example, a general purpose AM/FM radio receiver and speaker system installed in a vehicle. As shown in FIG. 1, amplifier 154 and RDS decoder 158 are coupled to FM tuner module 152 via buses 156 and 160, respectively. As also shown in FIG. 1, speaker 162 is coupled to amplifier 154 via bus 164 and display panel 166 is coupled to RDS decoder 158 via bus 168. As further shown in FIG. 1, FM tuner module 152 is coupled to antenna 152a.

As shown in FIG. 1, GPS receiver 110 can be configured to receive GPS signals through antenna 110a. The GPS signals can be, for example, signals transmitted from various GPS satellites which carry, for example, time and GPS coordinates of the portable electronic device. As also shown in FIG. 1, GPS receiver 110 can be configured to provide the GPS coordinates to CPU 104 via bus 112. CPU 104 can be configured to use the GPS coordinates data to retrieve various location-based information of interest from memory device 106 and/or cellular module 114. The location-based information of interest can be, for example, location related data such as the addresses and telephone numbers of various points of interests and services, for example, restaurants, gas stations, hotels, and turn-by-turn directions used in guiding a user of portable electronic device 100 from one location to another.

In one embodiment, the information of interest, for example the location related data, can be stored in memory device 106. Memory device 106 can be a non-volatile memory device, such as a flash memory device or a hard drive. In another embodiment, the location related data can be received by cellular module 114 through antenna 114a. For example, cellular module 114 can be a Global System Communication Service (“GSM”) compatible device capable of accessing the Internet using a data service, such as General Packet Radio Service (“GPRS”). Thus, the location related data can be updated and stored on a central database or server and received by cellular module 114 using techniques known in the art.

Thus, CPU 104 can be configured to process data which can include, for example, the address of a point of interest the user is traveling to or a driving direction, such as “turn left in one mile.” CPU 104 can be configured to process such data to generate text and/or audio signals containing the information of interest, for example, driving directions such as “turn left in one mile.” For example, CPU 104 can be configured to implement a text-to-speech algorithm to convert the text data described above into audio signals which, after further processing, can be amplified and output to a speaker. In one embodiment, the audio signals can be analog audio signals. In another embodiment, the audio signals can be digital audio streams. As shown in FIG. 1, CPU 104 can provide the text data to FM transmitter module 118 via text data bus 120 and/or can provide the audio signals to FM transmitter module 118 via analog audio bus 122 or digital audio bus 124.

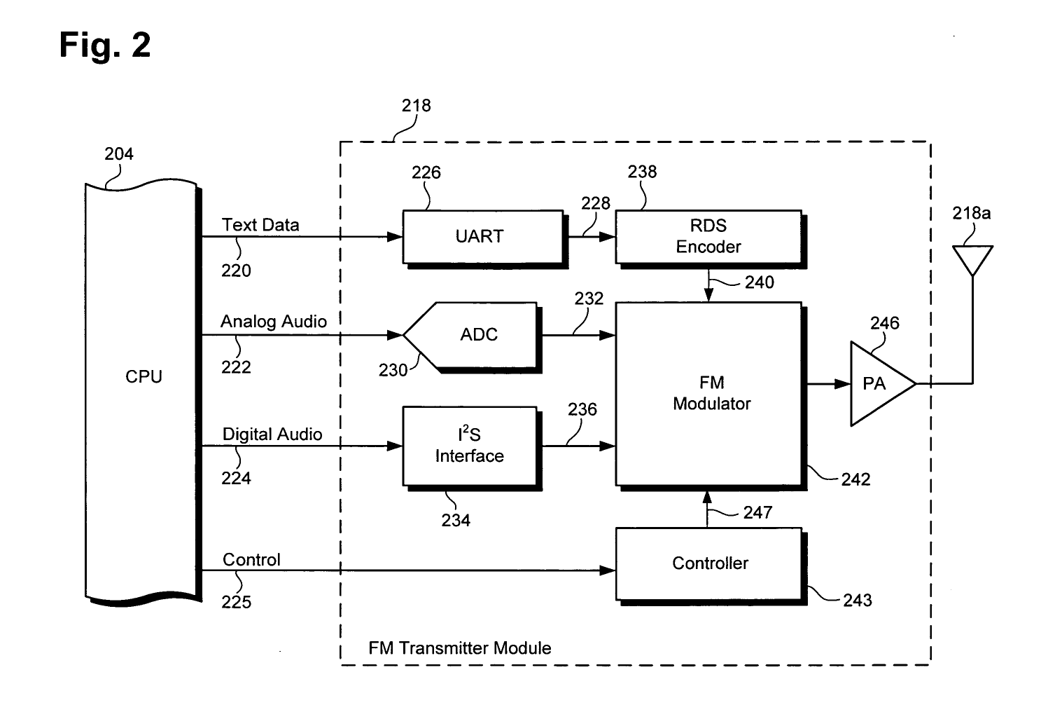

FIG. 2 shows a block diagram of an FM transmitter module coupled to a CPU in accordance with one embodiment of the invention. FM transmitter module 218 includes universal asynchronous receiver/transmitter (“UART”) 226, analog to digital converter (“ADC”) 230, Inter-IC Sound (“I²S”) interface 234, Radio Data System (“RDS”) encoder 238, FM modulator 242, controller 243, and power amplifier (“PA”) 246. In one embodiment, FM transmitter module 218, CPU 204, text data bus 220, analog audio bus 222, digital audio bus 224, control bus 225, and antenna 218a in FIG. 2 correspond to FM transmitter module 118, CPU 104, text data bus 120, analog audio bus 122, digital audio bus 124, control bus 125, and antenna 118a in FIG. 1, respectively.

As shown in FIG. 2, CPU 204 can provide text data to FM transmitter module 218 over text data bus 220 using UART 226. For example, the text data can be provided to FM transmitter module 218 in a serial data stream using techniques known in the art. The text data can be then provided to RDS encoder 238 via bus 228. In one embodiment, RDS encoder 238 can be configured to encode the text data into an RDS sub-carrier signal. For example, the RDS sub-carrier signal can have a frequency of approximately 57.0 kHz and can transmit the text data at a rate of approximately 1,180 bits per second (“bps”). In another embodiment, RDS encoder 238 can be a Radio Broadcasting Data System (“RBDS”) encoder and the RDS sub-carrier signal can be an RBDS sub-carrier signal. As also shown in FIG. 2, the RDS sub-carrier signal can be provided to FM modulator 242 via bus 240. FM modulator 242 in FIG. 2 can be configured to modulate the RDS sub-carrier signal on an FM signal. As further shown in FIG. 2, the FM signal generated by FM modulator 242 can be provided to the input of power amplifier 246, which can provide a suitable level of amplification for transmitting the FM signal from antenna 218a.

As shown in FIG. 2, CPU 204 can also be configured to provide the above-mentioned text data in audio form to FM transmitter module 218. In one embodiment, CPU 204 can provide the audio signals to FM transmitter module 218 as analog audio signals over analog audio bus 222. As shown in FIG. 2, ADC 230 can receive the analog audio signals and can provide a stream of digital outputs to FM modulator 242 via bus 232. Alternatively, CPU 204 can provide the audio signals to FM transmitter module 218 as digital audio data over digital audio bus 224. The digital audio data can be, for example, pulse-code modulation (“PCM”) data. Digital audio bus 224 can be, for example, a serial bus, such as an I²S bus. As shown in FIG. 2, the digital audio data can be received by FM transmitter module 218 using I²S interface 234 and provided to FM modulator 242 via bus 236. Once the digital audio data is received by FM modulator 242, the digital audio data can be modulated using an FM signal. The frequency of the FM signal can be, for example, between approximately 88.0 MHz and 108.0 MHz.

As also shown in FIG. 2, controller 243 in FM transmitter module 218 is coupled to CPU 204 via control bus 225 and to FM modulator 242 via bus 247. In other embodiments, controller 243 can be further coupled to one or more of the devices and interfaces included in FM transmitter module 218, such as RDS encoder 238 and UART 226. Controller 243 can be, for example, a microcontroller or any other type of controller. In one embodiment, controller 243 can be configured to control the frequency of the FM signal generated by FM modulator 242. For example, CPU 204 can communicate a desired frequency value to controller 243, which can then modify the modulation settings in FM modulator 242 to generate an FM signal having the desired frequency value. Thereafter, the FM signal can be amplified and transmitted from antenna 218a.

Referring now to FIG. 1, the FM signal transmitted from FM transmitter 118 can be received by FM receiver 150 via antenna 152a. FM tuner module 152 in FM receiver 150 can be tuned to the frequency of the FM signal and can be configured to demodulate the FM signal using techniques known in the art. RDS decoder 158 can be configured to determine the text data included in the RDS sub-carrier signal of the FM signal received by FM tuner module 152. The text data can then be provided to display panel 166 via bus 168, and thus displayed to the user. Display panel 166 can be, for example, any kind of digital display device, such as a liquid crystal display (“LCD”), a dot matrix display, or a light emitting diode (“LED”) display.

In one embodiment, FM tuner module 152 can be configured to decode the above-mentioned data included in the FM signal in audio form to generate an audio signal. The audio signal can be provided to amplifier 154 and thereafter to speaker 162 of FM receiver 150, thereby allowing the user to hear the audio data, in addition to viewing the text data displayed on display panel 166. In such an embodiment, the audio data can be heard from speaker 162 while the above-mentioned text data is displayed on display panel 166 of FM receiver 150. For example, if the text data being displayed on display panel 166 is “turn left in one mile,” then audio data for announcing the words “turn left in one mile” can be contemporaneously output through speaker 162 of FM receiver 150.

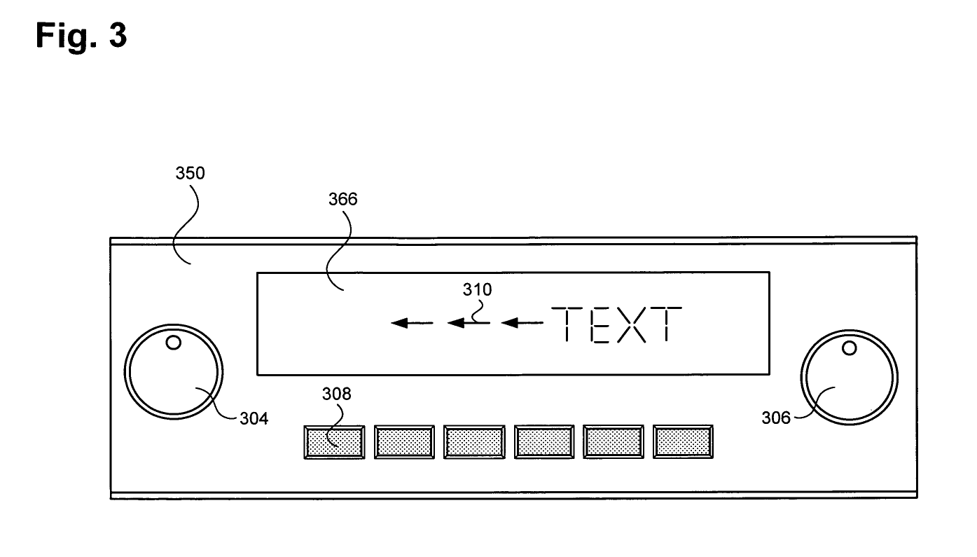

FIG. 3 shows a front view of an exemplary display panel 366, within a typical AM/FM receiver 350, referred to as FM receiver 350 for brevity, which can be installed and used in a typical vehicle. In addition to display panel 366, FM receiver 350 includes volume control dial 304, frequency control dial 306, and a number of station preset buttons, such as station preset button 308. In one embodiment, FM receiver 350 and display panel 366 correspond to FM receiver 150 and display panel 166 in FIG. 1, respectively.

FM receiver 350 can be configured to receive the FM signal transmitted from portable electronic device 100 (shown in FIG. 1) and can be configured to output the text data or combined text and audio data included in the FM signal. For example, the reception frequency of FM receiver 350 may be tuned using frequency control dial 306 such that the reception frequency of FM receiver 350 corresponds to the transmission frequency of the above-mentioned FM signal. In one embodiment, the user of portable electronic device 100 can select the transmission frequency of the FM signal by inputting a frequency value, such as 108.0 MHz, into portable electronic device 100. The user can then tune the reception frequency of FM receiver 350 also to 108.0 MHz, thereby enabling FM receiver 350 to tune to the FM signal transmitted from portable electronic device 100. In other embodiments, the transmission frequency of the FM signal from portable electronic device 100 and reception frequency of FM receiver 350 can be advantageously chosen to correspond to a frequency experiencing the least amount of noise or interference from existing FM radio stations or other interference or noise sources.

Once FM receiver 350 has received the FM signal, text data included in the FM signal can be decoded and displayed on display panel 366. For example, the text data can be configured to scroll at a comfortable reading pace on display panel 366, in the direction indicated by the arrows, such as arrow 310. If the FM signal includes audio data in addition to the text data, the audio data can be contemporaneously output through the speakers (not shown in FIG. 3) of FM receiver 350 as the text data is being scrolled across display panel 366.

Thus, the present invention enables, for example, data corresponding to GPS coordinates of an electronic device, i.e. location-based information, to be conveniently transmitted from a portable electronic device to an FM receiver using FM signals containing encoded text (such as RDS encoded text) or containing encoded text and audio signals. As such, various location-based information of interest can be conveniently displayed as text or displayed as text and also heard. Therefore, a user operating a moving vehicle can advantageously view, for example, location-based information, by quickly glancing at text data being conveniently displayed on an FM receiver already available and installed in the vehicle, thereby reducing the distraction to the user and increasing the user's safety. Moreover, in contrast to portable electronic devices which typically include weak integrated speakers that cannot be heard in noisy environments, the invention can transmit, for example, location-based information as audio data that can be heard through the much more powerful speakers typically found in vehicles, thus allowing the user to hear the information in noisy environments, in addition to contemporaneously viewing the information as text on the FM receiver display. In addition, since an embodiment of the present invention can use a cellular module to receive location-based information over a cellular network, the invention can ensure that the location-based information provided to the user is current and up to date.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

Thus, an electronic device for FM transmission of location-based information has been described.

1. An electronic device for transmitting location-based information corresponding to GPS coordinates of said electronic device to an FM receiver, said electronic device comprising:
a GPS receiver configured to receive said GPS coordinates;
a CPU configured to retrieve said location-based information corresponding to said GPS coordinates;
an FM transmitter module configured to encode and transmit said location-based information as encoded text.

2. The electronic device of claim 1 wherein said encoded text is an encoded RDS text.

3. The electronic device of claim 1 wherein said electronic device is a portable electronic device.

4. The electronic device of claim 1 wherein said electronic device is utilized to transmit said encoded text to an FM receiver installed in a vehicle.

5. The electronic device of claim 1 wherein said CPU is configured to retrieve said location-based information from a memory device coupled to said CPU.

6. The electronic device of claim 1 wherein said CPU is configured to retrieve said location-based information from a cellular module coupled to said CPU.

7. The electronic device of claim 1 wherein said FM transmitter module is further configured to transmit said location-based information as audio signals.

8. The electronic device of claim 7 wherein said CPU is configured to generate said audio signals by using a text-to-speech algorithm.

9. The electronic device of claim 7 wherein said electronic device is utilized to transmit said audio signals to an FM receiver installed in a vehicle.

10. The electronic device of claim 9 wherein said audio signals are broadcast by a speaker of said FM receiver in said vehicle.

11. The electronic device of claim 3 wherein said portable electronic device is selected from the group consisting of a cellular telephone, a portable navigation device, a personal digital assistant (“PDA”), and an MP3 player.

12. The electronic device of claim 4 wherein said FM receiver comprises an FM tuner module coupled to an RDS decoder.

13. The electronic device of claim 4 wherein said FM receiver comprises a display panel capable for displaying RDS text.

14. The electronic device of claim 1 wherein said location-based information includes driving directions.

15. The electronic device of claim 1 wherein said location-based information includes street address of a destination of interest to a user of said electronic device.

16. A portable electronic device for transmitting location-based information corresponding to GPS coordinates of said portable electronic device to an FM receiver in a vehicle, said portable electronic device comprising:
a GPS receiver configured to receive said GPS coordinates;
a CPU configured to retrieve said location-based information corresponding to said GPS coordinates;
an FM transmitter module configured to encode and transmit said location-based information as encoded text for displaying by a display panel of said FM receiver and as audio signals for broadcasting by a speaker of said FM receiver.

17. The portable electronic device of claim 16 wherein said encoded text is an encoded RDS text.

18. The portable electronic device of claim 16 wherein said CPU is configured to retrieve said location-based information from a memory device coupled to said CPU.

19. The portable electronic device of claim 16 wherein said CPU is configured to retrieve said location-based information from a cellular module coupled to said CPU.

20. The portable electronic device of claim 16 wherein said portable electronic device is selected from the group consisting of a cellular telephone, a portable navigation device, a personal digital assistant (“PDA”), and an MP3 player.
